(19) United States
(12) Patent Application Publication
(10) Pub. No.: US 2025/0307888 A1
(43) Pub. Date: Oct. 2, 2025

(54) SYSTEMS AND METHODS FOR USE IN REDUCING FRICTION IN NETWORK-BASED COMMUNICATIONS

(71) Applicant: MASTERCARD INTERNATIONAL INCORPORATED, PURCHASE, NY (US)

(72) Inventor: Manu Dharmaiah Kallugudde, Jersey City, NJ (US)

(21) Appl. No.: 18/617,544

(22) Filed: Mar. 26, 2024

(51) Int. Cl. G06Q 30/0601; G06F 21/62

(52) U.S. Cl. CPC G06Q 30/0609; G06F 21/6263

(57) ABSTRACT

Systems and methods are provided for reducing friction in network-based communication. One example method includes receiving a proxy from a first party, the proxy unique to a user; retrieving masked data based on the proxy, the masked data including an indicator of at least one account, the indicator being independent of an account number specific to the at least one account; causing the masked data to be displayed to the user, at a communication device of the user, whereby the user is informed of the masked data prior to being authenticated; receiving a selection of one of the at least one account; and in response: authenticating the user; and in response thereto, transmitting an account payload to the first party.

### FIELD

The present disclosure generally relates to systems and methods for use in reducing friction in network-based communications.

### BACKGROUND

This section provides background information related to the present disclosure which is not necessarily prior art.

Parties are known to offer various different products to users, and users are known to purchase such products. Specifically, in e-commerce purchase transactions, the users are not interacting physically or with the parties or individual representatives of the parties, but rather computers, websites or network-based applications, which may introduce opportunities for bad actors (e.g., fraudsters, etc.) to access, view, or steal information related to the purchase transactions (e.g., payment account credentials, etc.). In response, users are often cautious about not only the information that they provide, but also the sequences through which they provide the information. Certain sequences are then provided for purposes of improved security (e.g., authentication, etc.). In addition to, or occasionally contrary to, the required security, the users expect such e-commerce purchase transactions to be convenient and expedient.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in reducing friction in network-based communications;

FIG. 2 is a block diagram of an example computing device that may be used in the system of FIG. 1;

FIG. 3 is an example method that may be implemented in connection with the system of FIG. 1 for use in reducing friction in network-based communications; and

FIG. 4 illustrates a sequence of example interfaces, which may be displayed to a user at a communication device in connection with the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with e-commerce transactions (e.g., which include transactions between users and computers (e.g., websites, kiosks, etc.), users proceed through a sequence of steps to provide pertinent information about themselves, including names, billing addresses, shipping addresses, etc., through a sequence of interfaces. In addition, for click-to-pay (C2P) options, the users may be authenticated (e.g., via one-time-passcodes (OTPs), biometrics, etc.), generally, before a C2P backend displays options related to specific accounts of the users to select (i.e., where multiple payment accounts are associated with proxies). In connection therewith, the authentication of the users is a friction point, generally in sequence with the information being provided by the users, where the users are without feedback from the C2P backend, prior to authenticating. In response to the friction, it is common for users to abandon the e-commerce transactions.

Uniquely, the systems and methods herein provide masked data, in response to a proxy, whereby a user is provided feedback based on the proxy from a click-to-pay (C2P) backend, prior to authenticating, as part of the transaction. In particular, in connection with a C2P transaction, the user provides a proxy to initiate the transaction, and in response to the proxy, receives specific masked data, which is linked to the proxy, prior to solicitation of an authentication input from the user. In this way, the user receives feedback specific to the proxy and known to a proper, rightful C2P backend. As such, the user is reassured of the propriety of the transaction, and is further willing to provide the authentication input in connection with the transaction, as desired or required, resulting in a reduction in friction to the user. The systems and methods herein therefore provide a technical improvement, in connection with C2P transactions, and enhanced flexibility, over prior interactions, through at least reduced friction.

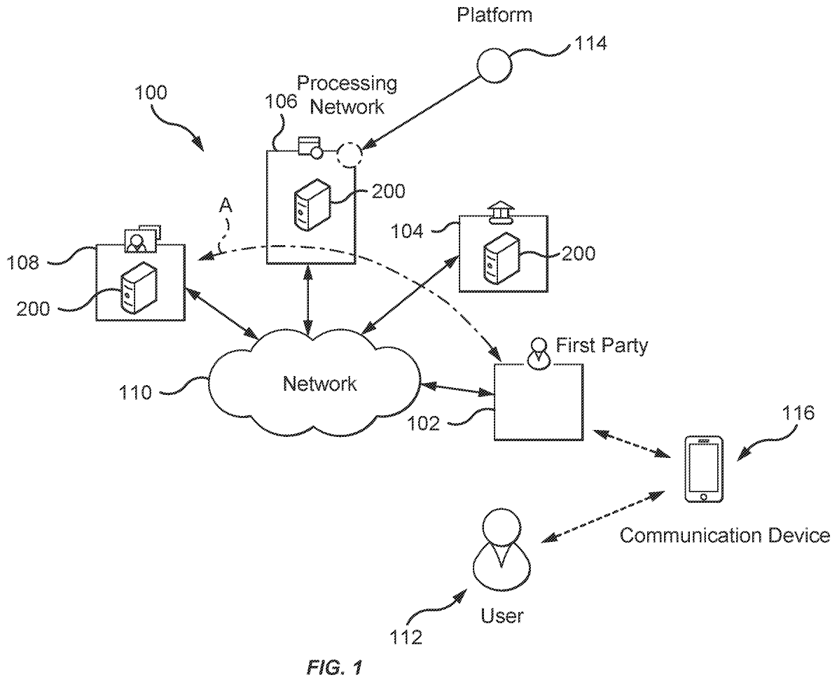

FIG. 1 illustrates an example system 100 in which one or more aspects of the present disclosure may be implemented. Although the system 100 is presented in one arrangement, other embodiments may include systems arranged otherwise depending, for example, on manners of identifying payment accounts, payment methodologies, privacy rules, regulations, and/or other concerns, etc.

In the illustrated embodiment, the system 100 generally includes a first party 102, an acquirer institution 104, a processing network 106, and an issuer institution 108, each coupled to (and in communication with) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (e.g., user 112, etc.), etc.

In this example embodiment, the first party 102 in the system 100 is generally a merchant associated with offering products (e.g., goods and/or services, etc.) for purchase to one or more users (including user 112). T

The first party 102 may offer the products for sale through a physical storefront and/or a virtual storefront, etc., for example, to the user 112. In this example embodiment, the first party 102 is associated with a virtual storefront, which is a website, through which the user 112 is permitted to purchase products. In other embodiments, the virtual storefront may include a network-based application, or other virtual-type interface, where the user is not present at the first party 102. In at least one embodiment, the virtual storefront is associated with or accessible at a physical storefront, for example, at a kiosk or other interface which permits the user to make a purchase to replace or augment interacting with an employee of the first party 102.

In this example embodiment, the acquirer institution 104 is a financial institution, such as, for example, a bank, etc. The acquirer institution 104 is configured to issue an account to the first party 102. The account may be a payment account, or checking account, or other type of bank account into which the first party 102 is permitted to received funds. Similarly, in this example embodiment, the issuer institution 108 is a financial institution, such as, for example, a bank, etc. The issuer institution 108 is configured to issue an account to the user 112. The account may be a payment account or other type of bank account from which the user 112 is permitted to pay funds to the first party 102, for example. Further, in this example, the account of the user 112 is associated with a primary account number or PAN.

The processing network 106 is configured to coordinate transactions between the account of the user 112, issued by the issuer institution 108, and the account of the first party 102, issued by the acquirer institution 104. The coordination of transactions includes, for example, the authorization, clearing, and/or settlement thereof, as explained in more detail below.

In addition to the payment account, the user 112 is also associated with a communication device 116. The communication device 116 may include a smartphone, a tablet, a personal computer, a laptop, a desktop, a workstation, a PDA, a server, etc., which is coupled to and/or is in communication with the first party 102 (e.g., via a web browser, or otherwise, etc.), for example, via the network 110.

As shown in FIG. 1, in this example embodiment, the processing network 106 is associated with a click-to-pay (C2P) platform 114. The C2P platform 114, or simply the platform 114, may be a standalone computing device, or may be included, in whole or in part, in the processing network 106, or potentially (in some example embodiments), the issuer institution 108.

The platform 114 is configured to coordinate messaging with the first party 102 to enable the user 112 to complete a click-to-pay transaction with the first party 102.

In particular, prior to interacting with the first party 102 (in connection with implementing the features herein), the user 112 interacts with the platform 114 to register for click-to-pay processing in connection with e-commerce interactions with the first party 102. For example, the user 112 accesses a website associated with the platform 114, via the communication device 116, and creates a user profile, which is specific to the user 112. In connection therewith, the platform 114 is configured to solicit, among other things, information related to the user 112 and information related to a payment account issued to the user 112 (e.g., by the issuer institution 108, etc.) and to be used for click-to-pay transactions. The information may include name, billing address, shipping address (e.g., acceptable shipping addresses, common shipping addresses, default shipping address, etc.), mobile phone number, email address, etc., as well as the PAN, expiration date, and card verification code (CVC) for the payment account. The platform 114 may further be configured to solicit a proxy to be used in click-to-pay transactions. The proxy may include, specifically, the mobile phone number or the email address of the user 112. The platform 114 is configured to receive the above information from the user 112, via the website, through the communication device 116, in this embodiment, and to store the information in the user profile for the user 112.

In addition to the above, the platform 114 may further be configured to capture certain information related to the communication device 116, such as, for example, MAC address, IP address, electronic serial number (ESN), operating system details, web browser details, location data, etc., and to store the captured information as part of the user profile.

Once registered with the platform 114, the user 112 is permitted to proceed to use click-to-pay with the first party 102, or other parties, to fund transactions.

That is, in one example transaction with the first party 102, the user 112 interacts with the first party 102, at a virtual storefront (e.g., website, kiosk, etc.) to purchase one or more products. Specifically, the user accesses the website of the first party 102, for example, via the communication device 116, and browses the products available for purchase. In response, the first party 102, via the website, displays the products available for purchase, along with associated information, to the user 112 (e.g., price, description, etc.), via the communication device 116. The user 112 may designate certain products for purchase whereby the products are added to a virtual shopping cart. When the user 112 is ready to check out, the user 112 selects an option (e.g., at a checkout page, etc.) for click-to-pay.

It should be appreciated that in other embodiments, for example, where the virtual storefront is a kiosk, the user 112 may add the product to the cart by scanning or otherwise identifying the product, and then selecting the option to click-to-pay when all products are scanned.

In response to the click-to-pay option, the first party 102 is configured to solicit information from the user 112, such as, for example, name, billing address, shipping address, etc. (e.g., where the virtual storefront is a website, etc.). In addition, the first party 102 is configured to solicit the proxy for click-to-pay, which the user 112 had previously registered with the platform 114. The user 112, in turn, enters or otherwise provides the proxy. The first party 102 (or platform 114) may require only one proxy, such as, for example, a mobile number, etc., or may require multiple proxies, such as, for example, a mobile phone number and an email address, etc.

In response to the proxy (or proxies), the first party 102 is configured to provide the proxy(ies) to the platform 114, as a lookup request. In turn, the platform 114 is configured to lookup the proxy(ies) in the various user profiles therein and to retrieve masked data for the account(s) registered to the user (and included in the associated user profile) and specific to the proxy(ies). As described herein, the masked data includes only indicators of the account, such as, for example, the name of the payment account (e.g., branding, card type, etc.) and card art associated with the payment account, etc. More generally, the masked data does not include the PAN (or any part of the PAN), and is insufficient to identify the payment account represented thereby (to the exclusion of other payment accounts).

The platform 114 is configured to cooperate with the first party 102 to display the masked data to the user 112 (e.g., card art with issuer name and card type thereon (but not the PAN or part of the PAN), etc.), and to solicit a selection of the payment account, based on the masked data, to be used in the transaction. In this way, the user 112 is informed of the registered account(s), which provides a valid feedback to the proxy from the user 112, thereby giving confidence in the propriety of the transaction.

The user 112 then responds by selecting the desired payment account. Based on the selection, the platform 114 is configured to then authenticate the user 112, based on an authentication input from the user 112 and/or other information. The authentication input may include a one time passcode (OTP), biometric, PIN, password, etc., while other information may include data specific to the communication device 116, the website of the first party 102, etc.

Specifically, in an example in which an OTP is used for authentication, the platform 114 is configured to generate the OTP, to send the OTP to the communication device 116 of the user 112, and to display an interface for entry of the OTP at the communication device 116. The OTP may be sent, for example, via an SMS message, email, etc. Upon receipt of the OTP, the user 112 enters the OTP into the interface displayed at the communication device 116. The platform 114 is configured to verify that the OTP received from the user 112 matches the OTP sent to the communication device 116. When there is a match, i.e., a successful authentication, the platform 114 is configured to provide a payment account credential for the selected account, which may include the PAN of the payment account or a representative token, to the first party 102.

Conversely, when there is no match, i.e., unsuccessful authentication, the platform 114 may be configured to respond with an error or other message indicative of a failed authentication.

It should be appreciated that a biometric, PIN, or password may be used to authenticate the user 112 in other examples, in lieu of the OTP (or any combination of such forms of authentication may be used). In such other examples, the platform 114 is configured to cooperate with the first party 102 to solicit the biometric, PIN or password, and then to compare the received biometric, PIN or password to content of the user profile identified by the proxy. When there is a match, as above, the user 112 is successfully authenticated.

In another example, along with the selection of the account, the platform 114 is configured to capture the device ID (e.g., IP address, MAC address, electronic serial number (ESN), etc.) associated with the communication device 116, or other information associated with the communication device 116, such as, for example, location, recognition token (i.e., indicative of a prior interaction between the communication device 116 and the first party 102), etc. The platform 114 is configured to leverage the captured data, rather than an authentication input from the user 112, to authenticate the user 112 with a sufficient confidence (e.g., again based on information included in the user profile for the user 112, as provided by the user 112 and/or as captured during registration; etc.).

Again, when the user 112 is authenticated, the platform 114 is configured to provide a payment account credential, which may include the PAN of the payment account or a representative token, to the first party 102.

It should again be appreciated that combinations of the above types of authentication may be used in still other system embodiments.

Thereafter, the first party is configured to generate an authorization message (i.e., authorization request) for the transaction to be funded by the user's payment account (including the PAN or representative token) and to communicate the authorization message to the acquirer institution 104 (along path A in FIG. 1). In turn, the acquirer institution 104 is configured to communicate the authorization message, along path A, generally to the processing network 106, such as, for example, through the MASTERCARD, VISA, or DISCOVER processing network, etc.

Upon receipt, the processing network 106 is configured to transmit the authorization message to issuer institution 108. The issuer institution 108 is configured to approve or decline the transaction based on, for example, criteria associated with the user 112 (e.g., adequate funds/credit in the user's account, etc.). In connection therewith, the issuer institution 108 is configured to compile an authorization message (i.e., an authorization reply in this instance), indicating the approval or decline, and to transmit the authorization message to the acquirer institution 104, via the processing network 106. The acquirer institution 104 is configured, in turn, to store the authorization message and to transmit the authorization message back to the first party 102.

At this point, the first party 102 is configured to deliver the purchased product to the user 112, whether in person or through shipment of the product to the user 112, potentially based on the result in the authorization message. The user 112 is then responsible to make payment consistent with the installment assigned to the transaction.

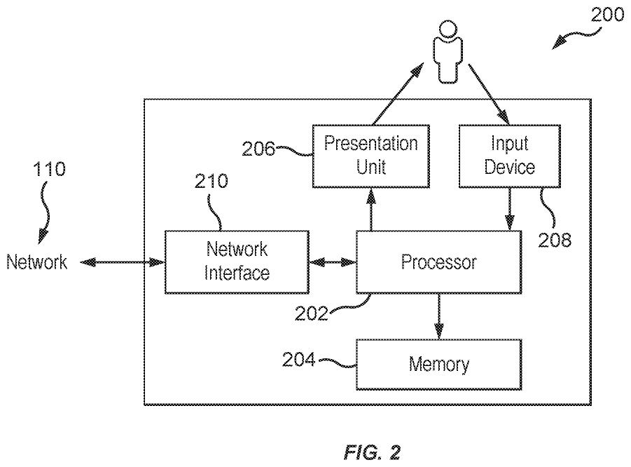

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the acquirer institution 104, the processing network 106, and the issuer institution 108 are illustrated as including, or being implemented in, computing device 200, coupled to the network 110. In addition, the user's communication device 116 may be considered a computing device consistent with computing device 200. What's more, the first party 102 and the C2P platform 114 may include and/or be implemented in at least one computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, proxies, user profiles, tokens, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein whereby, in connection with such performance, the computing device 200 may be transformed into a special-purpose computing device for managing network traffic. It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., click-to-pay interfaces, etc.), either visually or audibly, to a user of the computing device 200, for example, the user 112, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, selecting an account, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some example embodiments, the computing device 200 may include the processor 202 and one or more network interfaces (including the network interface 210) incorporated into or with the processor 202.

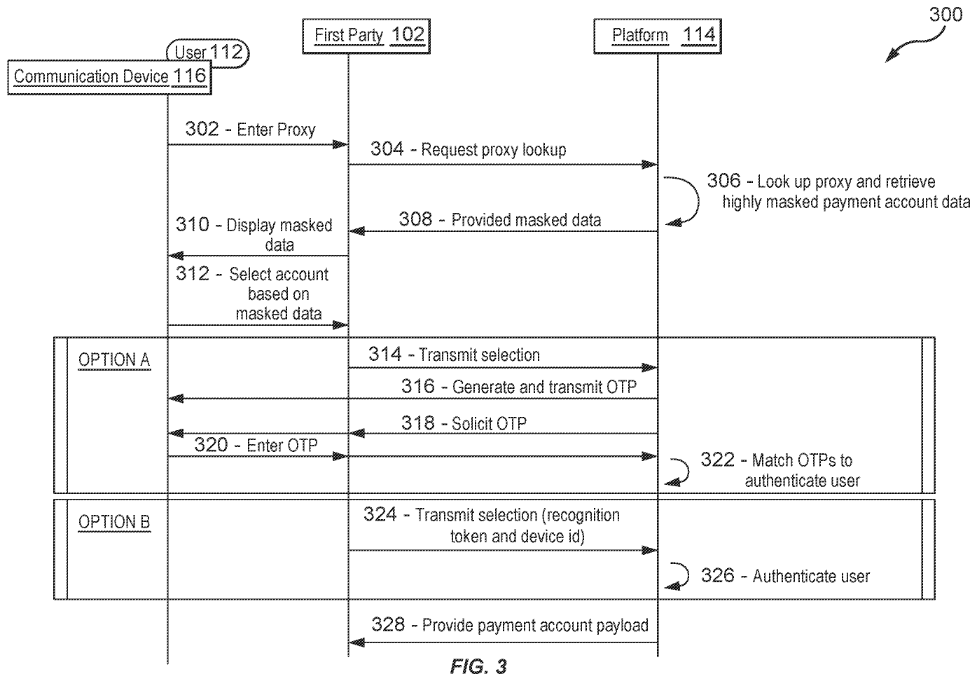

FIG. 3 illustrates an example method 300 for use in reducing friction in network-based communication. The example method 300 is described as implemented in the system 100 with reference made to the C2P platform 114, and further with reference to computing device 200. However, it should be understood that the method 300 is not limited to the above configuration of the system 100, as the method 300 may be implemented, at least in part, in other parts of the system 100, or in multiple other computing devices or systems. As such, the methods herein should not be understood to be limited to the example system 100 or the example computing device 200, and likewise, the systems and the computing devices herein should not be understood to be limited to the example method 300.

At the outset in the method 300, it should be appreciated that the user 112 is registered with the platform 114 for click-to-pay transactions, whereby the platform 114 includes a user profile for the user 112. The user profile includes a PAN or token for each payment account registered therein. In this example, the user profile includes two payment accounts, a Partner Bank, World Elite MASTERCARD credit card, and a Partner Bank, Travel MASTERCARD credit card. In addition, the user profile includes a proxy for the user 112, which, in this example, is an email address, name@mail.com. It should be appreciated that the user profile may include additional information, in general or specific to the user 112, the communication device 116, etc. For example, the user profile may included a biometric of the user 112, a MAC address of the communication device 116, or other information suitable to be used in authenticating the user 112.

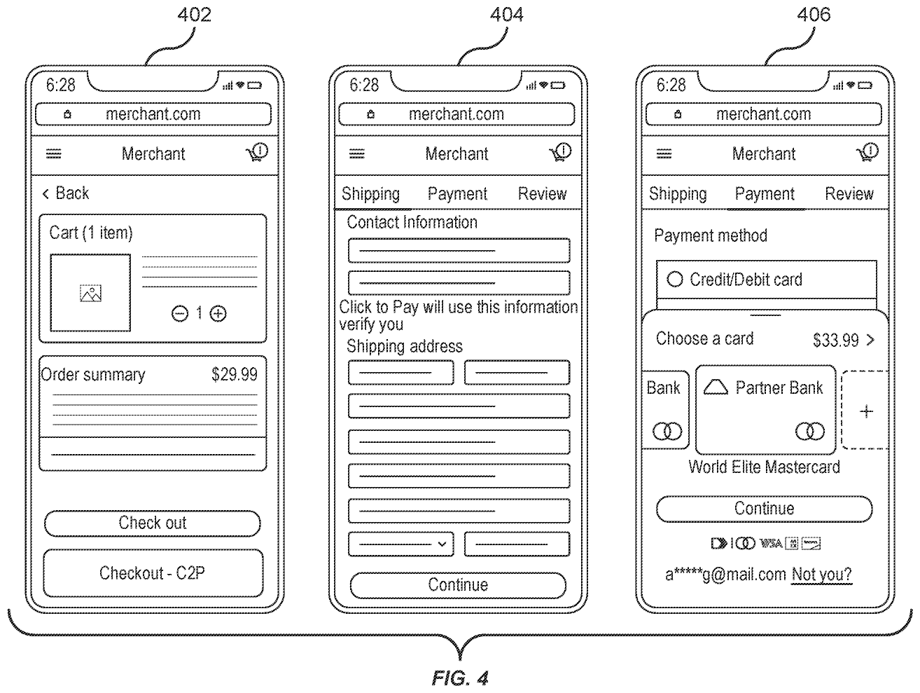

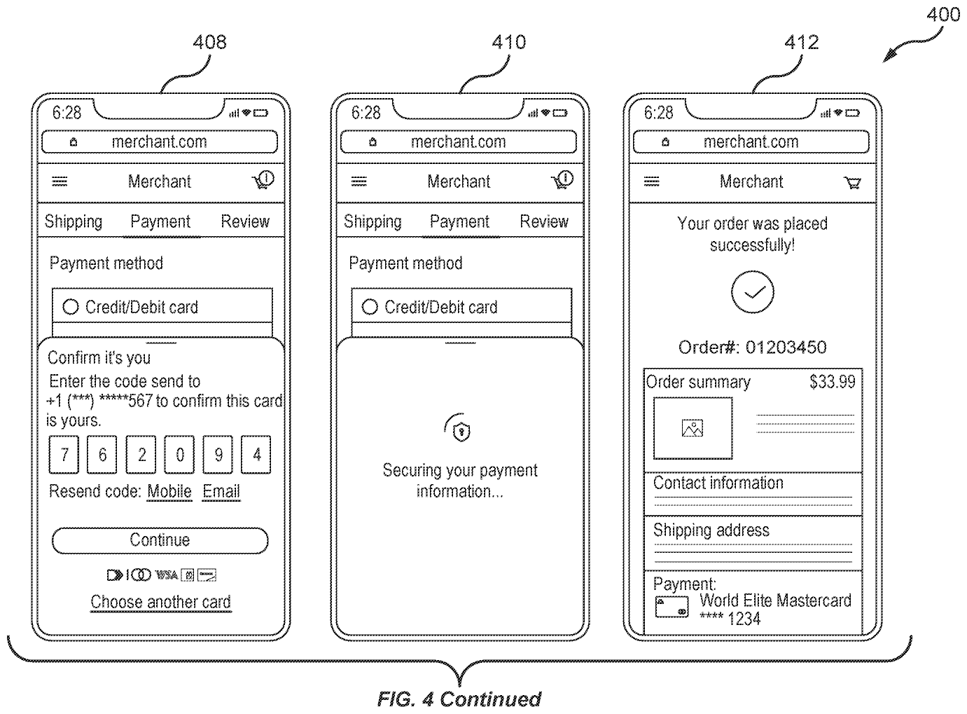

Also, the method 300 is described with reference to example interfaces 402-412 in FIG. 4, which illustrate information displayed to the user 112, as the method 300 progresses. That said, method 300 should not be understood to be limited to the example interfaces 402-412 in FIG. 4, as other example interfaces may be employed to present information to the user 112 and other users in other embodiments.

It should further be appreciated that the example interfaces 402-412 may be displayed to the user 112, at the communication device 116, by the first party 102, the platform 114, or a combination thereof. That is, the platform 114 may stand-in (e.g., via a lightbox popup, etc.) for the first party 102, or permit the first party 102 to receive and pass information between the user 112 and the platform 114, as desired. As such, any suitable combination of the first party 102 and the platform 114 may cooperate to provide the user experience explained below (e.g., and facilitate display of the interfaces 402-412, etc.).

Initially, the user 112 accesses a virtual storefront, such as, for example, a website, etc., associated with the first party 102 to browse products for purchase. In this example, at some point, the user 112 selects a product, from the first party 102, for purchase, adds the product to a shopping cart, and then opts to checkout, and specifically, to checkout through click-to-pay or C2P. As shown in FIG. 4, in connection with the above, the example interface 402 is displayed on the communication device 116 and illustrates the product being added to the shopping cart, and also the options to either checkout in a conventional manner (via the Check out button) or to checkout via C2P (click-to-pay) (via the Checkout—C2P button).

Upon selection of the checkout C2P option, the example interface 404 is displayed, by the first party 102, to the user 112 at the communication device 116. As shown, the example interface 404 solicits contact information and shipping address information from the user 112. Of note, the example interface 404 solicits a proxy (or proxies), as part of the contact information, where the proxy(ies) is(are) tied to the click-to-pay option for payment. As such, in response, the user 112 fills the solicited information into the example interface 404. In this example, as part of the contact information, the user 112 includes the proxy, which is the email address name@mail.com. When the user 112 selects to continue in the example interface 404, the entered information is provided to the first party 102. In this way, with reference to the method 300, the user 112 enters, or provides, at 302, the proxy to the first party 102.

In turn in the method 300, the first party 104 requests, at 304, a proxy look up with the platform 114. That is, the first party 102 accesses the click-to-pay option with the platform 114, by providing the proxy entered by the user 112. In response, at 306, the platform 114 looks up the proxy and retrieves masked data associated with the proxy. In particular, the platform 114 searches for the proxy in the various user profiles included in memory (e.g., the memory 204, etc.). When the proxy is matched to a user profile, the platform 114 retrieves the payment accounts included therein.

Optionally, the request, from the first party 102, may further include a device ID or location, etc., associated with the communication device 116, whereby the platform 114, in connection with matching the proxy(ies) also performs an authentication based on the device ID and/or location, and then, only retrieves the masked data when the probabilistic authentication satisfies a threshold. For example, where the IP address is located in South America, but the user profile is specific to the United states, the authentication may fail. Likewise, where an ESM of the communication device 116 is included in multiple user profiles with disparate proxies, the authentication may fail. It should be appreciated that any suitable, optional, authentication (absent a specific authentication input from the user 112, yet consistent with the description below) may be performed.

That said, with respect to the masked data, the platform 114 may retrieve only limited information about the payment accounts from the identified user profile, such as, for example, an issuer name and a card type, which may be highly masked data. As such, in this embodiment, the platform 114 retrieves Partner Bank, World Elite MASTERCARD credit card and a Partner Bank, Travel MASTERCARD credit card, as each is associated with the proxy name @mail.com, in the user profile for the user 112. It should be appreciated that additional information about the payment accounts may also be included in the highly masked payment account data, such as for example, card art or other indicator of the account, etc., but the specific PAN for the payment account, or part thereof, is not included in the highly masked payment account data (e.g., the highly masked data may exclude even the last four numbers of the PAN, as is often used to identify an account; etc.).

At 308, the platform 114 provides the masked data to the first party 102. In this example embodiment, the platform 114 also interacts with and/or is integrated with the virtual storefront of the first party 102, in a manner that permits the platform 114 to display, at 310, the masked data to the user 112. For instance, the platform 114 may display the example interface 406 (including the highly masked data) to the user 112, as a lightbox popup or otherwise. The example interface 406 is configured and/or stylized to at least partially mimic the virtual storefront of the first party 102, to provide a consistent look to the user 112. As shown, the example interface 406 includes an indicator of both of the payment accounts identified by the highly masked payment account data, and in particular, includes card art for each of the payment accounts. In this manner, the user 112 is provided with feedback (in the absence of an authentication input from the user 112) based on the entry of the proxy, which is indicative of accounts registered to click-to-pay but without disclosing the PAN associated with the payment accounts. In addition, in this example, the proxy is also displayed as part of the example interface 406, so that the user 112 can further perceive the indicators of both the payment accounts are tied to the proxy.

At 312, the user 112 selects the indicator of one of the accounts, such as, for example, the Partner Bank, World Elite MASTERCARD credit card, and in doing so, selects the underlying account to fund the click-to-pay transaction.

Next, the platform 114 authenticates the user 112, prior to proceeding with the transaction (e.g., providing payment account credentials, etc.). As shown in FIG. 3, the method 300 includes two options to authenticate the user 112, in response to the selection of the account: option A and option B. Option A includes a one time passcode (OTP) authentication of the user 112, while option B relies on a recognition token to authenticate the user 112.

Specifically, as shown, for option A, the first party 102 provides, at 314, the selection of the account back to the platform 114 (where the platform 114 essentially communicates directly with the user 112, via the lightbox popup). In turn, at 316, the platform 114 generates an OTP and transmits the OTP to the user 112, at the communication device 116. The platform 114 transmits the OTP in an email, a text message, or an application notification, etc., directly to the communication device 116 and/or the user 112. In addition, at 318, the platform 114 solicits the OTP from the user 112, at the communication device 116, via the first party 102. Example interface 408 illustrates an example solicitation of the OTP from the user 112 (as sent to the user 112 at the communication device 116 via text message).

In response, the user 112 enters, at 320, the OTP to the example interface 408 and submits the same to the platform 114, via the first party 102. The example interface 410 is then shown to the user 112 at the communication device 116, as the method 300 proceeds.

Upon receipt of the OTP, the platform 114 matches, at 322, the OTPs, i.e., the OTP generated by the platform 114 and the OTP received from the user 112. When the OTPs match, the platform 114 determines that the authentication of the user 112 is successful (i.e., the user 112 is indeed authenticated).

It should be appreciated that the authentication in option A may be employed with a biometric, PIN or password, where the authentication input received from the user 112, via the first party 102, is compared to a reference biometric, PIN or password included in the user profile identified by the proxy (i.e., the source of the masked data).

With regard to option B, at 324, the first party 102 transmits the selection of the account by the user 112 and a recognition token specific to the first party 102, and potentially, additional or alternative information specific to the communication device 116 (e.g., location, device ID and/or name, browser details, version and/or type, IP address, screen resolution, email address, mobile phone number, mailing and/or residential address, etc.). The recognition token is generated at the communication device 116 based on one or more prior interactions between the communication device 116 (and the web browser therein) and the first party 102. That is, the recognition token is generated and signed by the browser, based on a successful interaction between the communication device 116 and the first party 102. That is, the recognition token is generated after one successful consumer authentication and checkout with the first party 102 at the communication device 116. The recognition token includes, in this example, a JSON Web Token (JWT), which is linked upon creation to the user profile (e.g., of the user 112, etc.) for use in future interactions. Then, in subsequent checkouts (broadly, interactions), the first party 102 passes that recognition token as provided herein.

In the meantime, it should be appreciated that example interface 408 may be omitted, when method 300 proceeds consistent with option B, as there is no OTP to be entered by the user 112.

At 326, based on the recognition token and/or additional information received from the first party 102 (from the communication device 116), the platform 114 performs an authentication of the user 112.

In general, the authentication may include a probabilistic authentication, which may be based on verification of the signature on the recognition token, a comparison between the location of the communication device 116 and a location associated with the first party 102 and/or the user 112, a history associated with the device ID (e.g., use of the communication device 116 in prior transactions, etc.), etc.

For example, the platform 114 may receive the shipping address with the selection of the account (or the proxy) from the first party 102. The platform 114 may then compare the shipping address and payment account credential combination for prior use. When the combination has been used prior, the platform 114 may successfully authenticate the user 112. It should be appreciated that any different combination of the information for the transaction and the information included in the user profile may be used in still other examples. In another example, the location of the communication device 116, as indicated in the additional information, may be compared to a billing address or one or more shipping address included in the user profile. The location may be generic to a region, city, postal code, X mile radius (where X is 1, 2, 4, 5, 10, etc.), etc., or precise to a limited distance from one of the addresses in the user profile.

When the authentication indicates that the proxy is indeed the user 112, the platform 114 considers the user to the authenticated.

Regardless of whether method 300 proceeds with option A or option B, when the user 112 is authenticated, the platform 114 retrieves a payment account credential associated with the account selected by the user 112 (e.g., at step 312, etc.) and provides, at 328, the account credential to the first party 102 as part of a payment account payload. The payment account credential may include the PAN for the payment account, or a token representative of the payment account. The payment account payload may further include an expiration date, CVC, billing address, shipping address, etc.

Although not shown, upon receipt of the payload, the first party 102 compiles an authorization message for the transaction and transmits the authorization message to the acquirer institution 104. The authorization message for the transaction includes, without limitation, the amount of the transaction and the payment account credential from the payload. In response to the authorization message, the acquirer 104 forwards the authorization message to the processing network 106, which in turn forwards the authorization request to the issuer institution 108. The issuer institution 108 then decides whether to authorize or decline the transaction, generally, based on the data included in the authorization message. In turn, the issuer institution 108 compiles an authorization reply indicating either the authorization or decline of the transaction and transmits the authorization reply to the processing network 106. The processing network 106 then forwards the authorization reply to the acquirer institution 104, which, in turn, then forwards the authorization reply to the first party 102.

In connection therewith, the example interface 412, from FIG. 4, is displayed to the user 112 at the communication device 116, which indicates that the transaction has been completed successfully. The first party 102 is the permit to deliver the product to the user 112, directly or via one or more carriers (e.g., delivery services, etc.).

Thereafter, at a suitable clearing intervals, the acquirer institution 104 compiles and forwards a clearing file, which includes the transaction, to the processing network 106. The processing network 106 then clears and settles the transaction among the acquirer institution 104 and the issuer institution 108.

In view of the above, the systems and methods herein provide for reducing friction in network-based communication. In particular, by informing the user of the accounts available for selection, prior to authenticating the user, the user receives feedback from the submission of the proxy in connection with initiating an e-commerce transaction. The feedback includes masked data, which is known to the platform (based on the user's registration therewith), but not another party (e.g., a fraudster, bad actor, etc.). As such, the feedback serves to validate the overall interaction by the user with the first party, and permits the user to provide authenticating inputs (e.g., OTP, biometric) with additional confidence that the interaction is appropriate (or legit). In this way, there is a reduced likelihood that the user will abandon the transaction when an authentication input is solicited. This defines reduced friction in the e-commerce, network-based interaction.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a proxy from a first party, the proxy unique to a user; (b) retrieving masked data based on the proxy, the masked data including an indicator of at least one account, the indicator being independent of an account number specific to the at least one account; (c) causing the masked data to be displayed to the user, at a communication device of the user, whereby the user is informed of the masked data prior to being authenticated; (d) receiving a selection of one of the at least one account; and (e) in response to the selection of the one of the at least one account: authenticating the user; and, in response to authenticating the user, transmitting an account payload to the first party.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in reducing friction in network-based communication, the method comprising:
receiving, at a platform computing device, a proxy from a first party, the proxy unique to a user;
retrieving, by the platform computing device, masked data based on the proxy, the masked data including an indicator of at least one account, the indicator being independent of an account number specific to the at least one account;
causing, by the platform computing device, the masked data to be displayed to the user, at a communication device of the user, whereby the user is informed of the masked data prior to being authenticated;
receiving, by the platform computing device, a selection of one of the at least one account; and
in response to the selection of the one of the at least one account:
authenticating, by the platform computing device, the user; and
in response to authenticating the user, transmitting, by the platform computing device, an account payload to the first party.

2. The computer-implemented method of claim 1, wherein the at least one account includes a first account and a second account;
wherein the indicator of the first account includes a name of the first account and the indicator of the second account includes a name of the second account; and
wherein the selection of the one of the at least one account includes a selection of the first account.

3. The computer-implemented method of claim 2, wherein the indicator for the first account includes card art for the first account.

4. The computer-implemented method of claim 1, wherein authenticating the user includes:
generating and transmitting a first one-time-passcode (OTP) to the user, at the communication device;
receiving a second OTP from the user, via the first party; and
matching the first OTP to the second OTP, whereby a match indicates the user being authenticated successfully.

5. The computer-implemented method of claim 1, further comprising receiving a device identifier (ID) specific to the communication device with the selection of the one of the at least one account; and
wherein authenticating the user includes authenticating the user based on the device ID, without any further data from the user.

6. The computer-implemented method of claim 5, wherein authenticating the user is further based on a recognition token associated with a website of the first party; and
wherein receiving the proxy includes receiving the proxy via the website of the first party.

7. The computer-implemented method of claim 1, wherein the proxy includes a phone number specific to the user and/or an email address associated with the user.

8. The computer-implemented method of claim 7, wherein the account payload includes a payment account credential for the account; and
further comprising, receiving an authorization request including the payment account credential, from an acquirer institution associated with the first party.

9. A non-transitory computer readable storage medium including executable instructions for use in reducing friction in network-based communication, which when executed by at least one processor of a platform, cause the at least one processor to:
receive a proxy from a first party, the proxy unique to a user;
retrieve masked data based on the proxy, the masked data including an indicator of at least one account, the indicator being independent of an account number specific to the at least one account;
cause the masked data to be displayed to the user, at a communication device of the user, whereby the user is informed of the masked data prior to being authenticated;
receive a selection of one of the at least one account; and
in response to the selection of the one of the at least one account:
authenticate the user; and
in response to authenticating the user, transmit an account payload to the first party.

10. The non-transitory computer readable storage medium of claim 9, wherein the at least one account includes a first account and a second account;
wherein the indicator of the first account includes a name of the first account and the indicator of the second account includes a name of the second account; and
wherein the selection of the one of the at least one account includes a selection of the first account.

11. The non-transitory computer readable storage medium of claim 10, wherein the indicator of the first account further includes card art for the first account.

12. The non-transitory computer readable storage medium of claim 9, wherein the executable instructions, when executed by the at least one processor, cause the at least one processor, in authenticating the user, to:
generate and transmit a first one-time-passcode (OTP) to the user, at the communication device;
receive a second OTP from the user, via the first party; and
match the first OTP to the second OTP, whereby a match indicates the user being authenticated successfully.

13. The non-transitory computer readable storage medium of claim 9, wherein the executable instructions, when executed by the at least one processor, further cause the at least one processor to:
receive a device identifier (ID) specific to the communication device with the selection of the one of the at least one account; and
authenticate the user based on the device ID, without any further data from the user.

14. The non-transitory computer readable storage medium of claim 9, wherein the proxy includes a phone number specific to the user and/or an email address associated with the user.

15. The non-transitory computer readable storage medium of claim 14, wherein the account payload includes a payment account credential for the account; and
wherein the executable instructions, when executed by the at least one processor, further cause the at least one processor to receive an authorization request including the payment account credential, from an acquirer institution associated with the first party.

16. A system for use in reducing friction in network-based communication, the system comprising:
a platform computing device, which is configured to:
receive a proxy from a first party, the proxy unique to a user;
retrieve masked data based on the proxy, the masked data including an indicator of at least one account, the indicator being independent of an account number specific to the at least one account;
cause the masked data to be displayed to the user, at a communication device of the user, whereby the user is informed of the masked data prior to being authenticated;
receive a selection of one of the at least one account; and
in response to the selection of the one of the at least one account:
authenticate the user; and
in response to authenticating the user, transmit an account payload to the first party.

17. The system of claim 16, wherein the at least one account includes a first account and a second account;
wherein the indicator of the first account includes a name of the first account and card art for the first account; and
wherein the indicator of the second account includes a name of the second account and card art for the second account.

18. The system of claim 17, wherein the platform computing device is further configured to:
receive a device identifier (ID) specific to the communication device with the selection of the one of the at least one account; and
authenticate the user based on the device ID.

19. The system of claim 17, wherein the platform computing device is configured, in authenticating the user, to:
generate and transmit a first one-time-passcode (OTP) to the user, at the communication device;
receive a second OTP from the user, via the first party; and
match the first OTP to the second OTP, whereby a match indicates the user being authenticated successfully.
